(19) United States
(12) Patent Application Publication
(10) Pub. No.: US 2024/0375934 A1
(43) Pub. Date: Nov. 14, 2024

(54) CONTAINER CAPABLE OF DISPLAYING FLOW RATE

(71) Applicant: Kuan Ming CHEN, Tainan City (TW)

(72) Inventor: Kuan Ming CHEN, Tainan City (TW)

(21) Appl. No.: 18/656,879

(22) Filed: May 7, 2024

(30) Foreign Application Priority Data
May 11, 2023 (TW) 112204610

(51) Int. Cl. B67D 3/00

(52) U.S. Cl. CPC B67D 3/0077; B67D 3/0051

(57) ABSTRACT

A container capable of displaying a flow rate includes a container body and a flowmeter, a display, and a control circuit module mounted therein. The container body has a channel. The flowmeter has a conduit fluidly communicating with the channel for sensing a liquid flow. The control circuit module is signally connected to the flowmeter and the display to control the display to show a flow rate based on a measurement signal of the flowmeter.

### CROSS REFERENCE TO RELATED APPLICATION(S)

This application claims the priority to patent application No. 112204610 filed in Taiwan on May 11, 2023, which is hereby incorporated in its entirety by reference into the present application.

### BACKGROUND OF THE INVENTION

### 1. Field of the Invention

The present invention relates to a container, in particular to a container capable of displaying a flow rate.

### 2. Description of the Related Art

Containers can be used to hold liquids and to transfer the liquids therein to other places or objects; for example, a kettle is one of the common containers for containing water, and the water in it can be poured out into a cup.

Taking the scene of coffee brewing as an example, a consumer nowadays mainly places a coffee pot on a digital scale, and the top side of the coffee pot is equipped with filter papers and coffee powder. The consumer can take a gooseneck kettle over the top of the coffee pot and pour water onto the filter paper to brew the coffee powder, and find out an amount of water discharged from the gooseneck kettle through the weight data shown by the digital scale. The uniqueness of hand-drip coffee lies in the fact that the flavor of hand-drip coffee is closely related to the consumer's hand-drip skills. During the dripping and brewing process, the consumer can control the amount of water discharged from the gooseneck kettle according to the characteristics of the coffee beans and the coarseness of the powdered coffee particles, and carefully observes subtle changes in the amount of water discharged from the gooseneck kettle.

However, for a consumer, he/she needs to pay close attention to the changes in the flow of water from the spout of the gooseneck kettle on one hand, and to observe the weight data on the digital scale on the other hand. As a height difference exists between the spout of the gooseneck kettle and the digital scale, the consumer is distracted from alternatingly and repeatedly observing the above two information, which makes it difficult to grasp the coffee brewing status, especially for a beginner.

### SUMMARY OF THE INVENTION

In view of the above-mentioned, the main purpose of the present invention is to provide a container capable of displaying a flow rate, with a view to overcome the shortcomings of conventional containers described in the prior art that makes it difficult for consumers to keep track of the coffee brewing status.

The container capable of displaying a flow rate of the present invention includes:
a container body having a channel;
a flowmeter, mounted in the container body and having a conduit for sensing a liquid flow, wherein the conduit fluidly communicates with the channel of the container body;
a display, mounted on the container body; and
a control circuit module, mounted in the container body and signally connected to the flowmeter and the display, wherein the control circuit module controls the display to show a flow rate based on a measurement signal of the flowmeter.

The liquid contained in the container of the present invention is water as an example. When a consumer lifts the container of the present invention for pouring, the water flows out of the container body through the conduit of the flowmeter and the channel of the container body in sequence. When the water passes through the conduit of the flowmeter, the flowmeter is configured to correspondingly generate and output a measurement signal so that the measurement signal received by the control circuit module from the flowmeter corresponds to the flow rate of the water, and the display is controlled by the control circuit module to show the flow rate so that the consumer can directly observe the flow rate shown on the display. As a result, the consumer can control the water output more prudently and conveniently.

For example, in the scenario of hand-drip coffee, when a consumer takes the container of the present invention for pouring, the consumer can directly observe the flow rate shown on the display on the container of the present invention to know how much water is being poured out, and to carefully control the amount of water without distraction due to the needs to alternatingly and repeatedly observe the changes in both the flow of water at the spout of the gooseneck kettle and the weight data of the digital scale underneath as described in the prior art. As a result, it is easier for the consumer to control the status of coffee brewing through the container of the present invention, so as to realize high quality hand-drip coffee.

In order to make the above objects, features and advantages of the present invention more apparent and easier to understand, the following embodiments, together with the accompanying drawings, are described in detail as follows.

### BRIEF DESCRIPTION OF THE DRAWINGS

FIG. 1 is a side plane view of an embodiment of the container capable of displaying a flow rate of the present invention;

FIG. 2 is a planar exploded view of an embodiment of the container capable of displaying a flow rate of the present invention;

FIG. 3 is a circuit block diagram of the container capable of displaying a flow rate of the present invention;

FIG. 4 is an operation scenario view of the container capable of displaying a flow rate of the present invention;

FIG. 5 is a partial top plan view of an embodiment of the container capable of displaying a flow rate of the present invention;

FIG. 6 is a partial cross-sectional view of another embodiment of the container capable of displaying a flow rate of the present invention;

FIG. 7 is a circuit block diagram of another embodiment of the container capable of displaying a flow rate of the present invention; and

FIG. 8 is a schematic view of the container capable of displaying a flow rate of the present invention mounted on a base.

### DETAILED DESCRIPTION OF THE INVENTION

The technical solution of the present invention is further described below in conjunction with the accompanying drawings and by means of specific embodiments. In the description of the present invention, it is to be understood that the terms “center”, “longitudinal”, “lateral”, “length”, “width”, “thickness”, “top”, “bottom”, “left”, “right”, “vertical”, “horizontal”, “top”, “bottom”, “inner”, “outer”, “axial”, “radial”, “circumferential” and the like indicate orientation or positional relationships based on those shown in the accompanying drawings, and are intended only to facilitate the description of the present invention and to simplify the description, and are not intended to indicate or imply that the device or element referred to must have a particular orientation, or be constructed and operated in a particular orientation and therefore cannot be construed as limitations of the present invention.

Furthermore, the terms “first” and “second” are used for descriptive purposes only and are not to be understood as indicating or implying relative importance or implicitly specifying the number of technical features indicated. Thus, the feature defined with “first”, “second” may include one or more such features, either explicitly or implicitly. In the description of the present invention, unless otherwise specified, “more than one” means two or more.

In the description of the present invention, it is to be noted that, unless otherwise expressly specified and limited, the terms “mounted”, “connected”, and “connecting” are to be understood in a broad sense. For example, it may be a fixed connection, a removable connection, or a connection in one piece; it may be a direct connection, an indirect connection through an intermediate medium, or a connection within two elements. For a person of ordinary skill in the art, the specific meaning of the above terms in the present invention may be understood in a specific context.

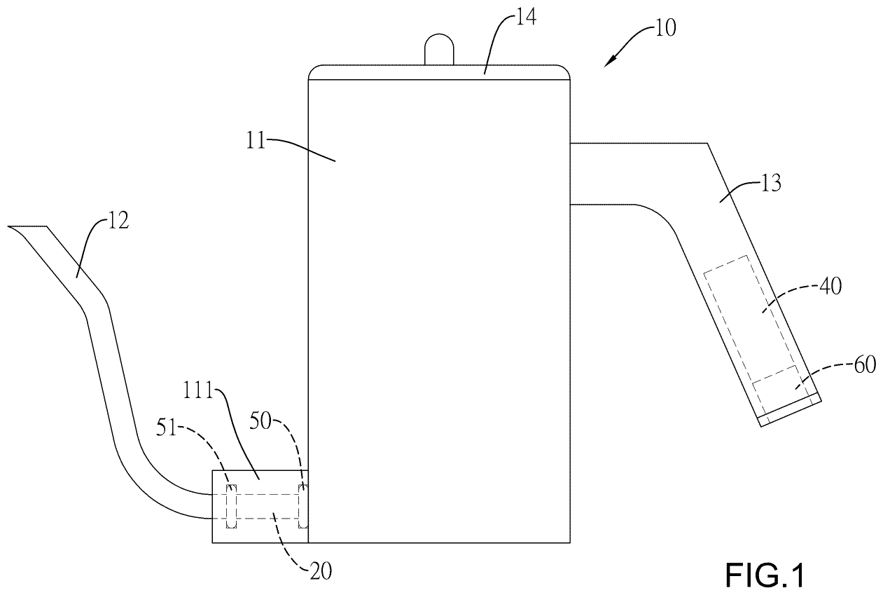

Referring to FIGS. 1, 2 and 3, the container capable of displaying a flow rate of the present invention comprises a container body 10, a flowmeter 20, a display 30, and a control circuit module 40.

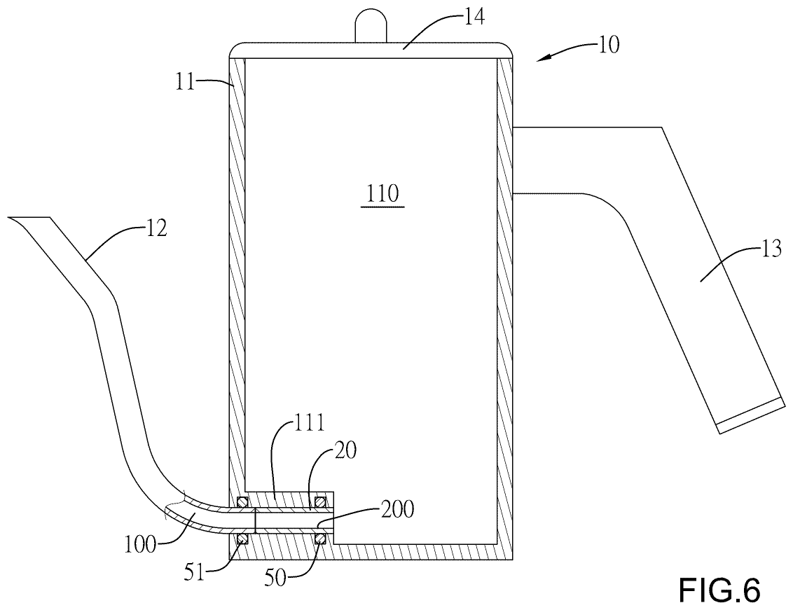

The container body 10 has a channel 100 through which liquid can flow out of the container body 10 when a user wants to pour liquid out of the container body 10. In one embodiment, the container body 10 comprises a body portion 11 and a spout portion 12 mounted on the body portion 11. The spout portion 12 may be integrally formed on the body portion 11. Or the spout portion 12 may be detachably connected to the body portion 11. For example, the spout portion 12 may be snap-fitted, screwed, glued, or tightly fixed to the body portion 11. The channel 100 is formed within the spout portion 12, and the channel 100 fluidly communicates with an accommodation space of the body portion 11 (such as the accommodation space 110 shown in FIG. 6). The accommodation space 110 of the body portion 11 may contain food or non-food stuff in liquid form. For example, the body portion 11 may be a jug, a bottle, ajar, a cup, a bowl, a pot, a basin, or a bucket; for example, said liquid food may be water, oil, tea, wine, coffee, milk, juice, soup, or flavoring sauce (e.g., soy sauce, vinegar, etc.), and said liquid non-food stuff may be alcohol, other chemical solutions, etc. The body portion 11 may, for example, be made of stainless steel, ceramic, plastic, or glass. The spout portion 12 may, for example, be a tubular body. On the other hand, the container body 10 may comprise a grip portion 13, which may be a handle mounted on a side wall of the body portion 11 for a user to hold. As in the embodiment shown in FIG. 1, the body portion 11 is a bottle which may have a lid 14 on a top side of the body portion 11, and the spout portion 12 is a gooseneck spout, which may be mounted in a position opposite to the grip portion 13.

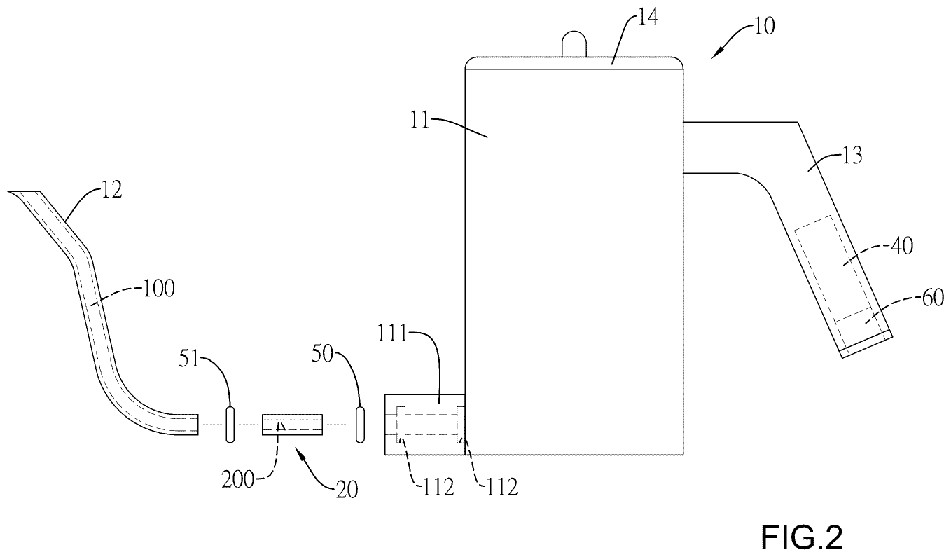

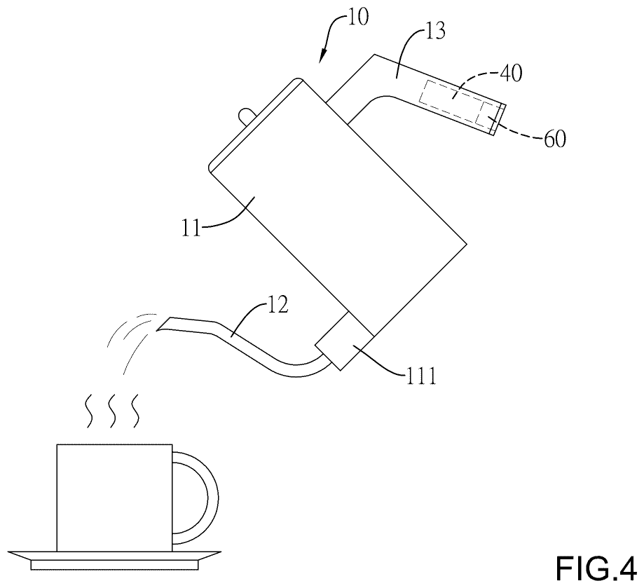

The flowmeter 20 is mounted in the container body 10, and seal rings 50, 51 may be mounted between the flowmeter 20 and the container body 10 to prevent leakage of liquid. The flowmeter 20 has a conduit 200 for sensing liquid flow. The conduit 200 fluidly communicates with the channel 100 and the accommodation space 110 of the body portion 11, wherein the conduit 200 may directly fluidly communicates with the channel 100, so that when a user pours out liquid from the container body 10, referring to FIGS. 2 and 4, the liquid can flow out of the container body 10 through the conduit 200 and the channel 100. The flowmeter 20 may be a commercially available electronic product with operation principles belonging to common knowledge in related technical fields. In short, the flowmeter 20 generates a measurement signal that corresponds to a flow rate of the liquid through the conduit 200, so that the flowmeter 20 can directly measure the volume or mass of the liquid stream. For example, the types of the flowmeter 20 may include, but are not limited to, a gas volume measurement flowmeter, a differential pressure flowmeter, a rotor flowmeter, a volumetric flowmeter, an electromagnetic flowmeter, and an ultrasonic flowmeter.

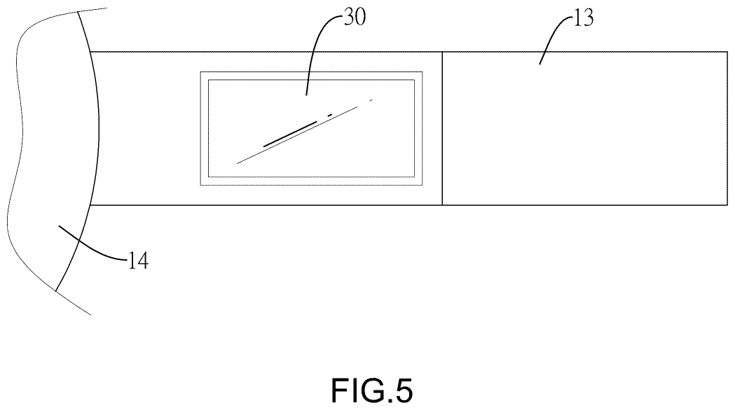

The display 30 is mounted on the container body 10 to provide information display function. The display 30 can be, for example, a flexible display, a liquid crystal display, a light emitting diode seven-segment display, or other types of displays. For example, the display 30 can be mounted on the body portion 11 or the grip portion 13 of the container body 10. In an embodiment shown in FIG. 5, the display 30 is mounted on a top side of the grip portion 13.

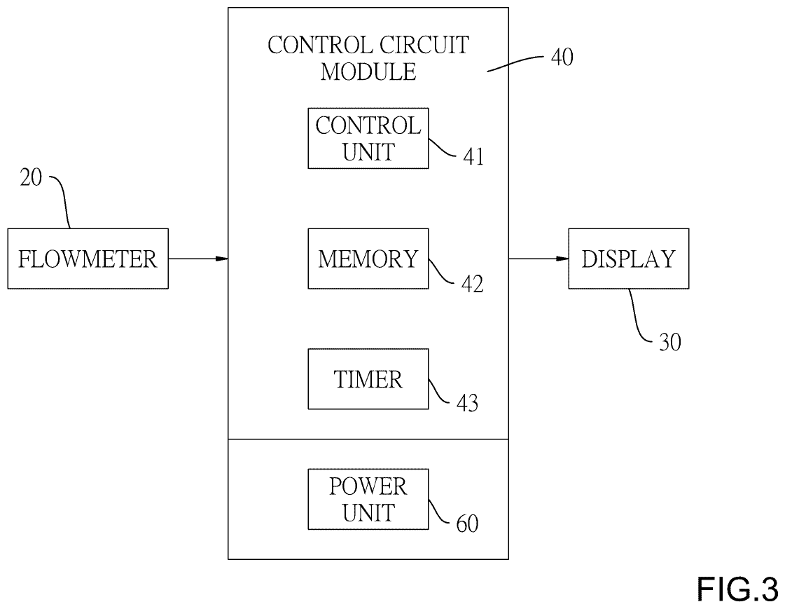

The control circuit module 40 mainly provides data computing and control functions. For example, the control circuit module 40 can be a micro control unit (MCU) circuit module. Please refer to FIG. 3: the control circuit module 40 may include a control unit 41, a memory 42, a timer 43, input/output (I/O) interfaces, etc., but not limited thereto. The control unit 41 may be a microcontroller chip, and the timer 43 may be realized by a clock software function of the control unit 41.

The control circuit module 40 is mounted in the container body 10, for example, in the body portion 11 or the grip portion 13. For example, referring to FIG. 1, the control circuit module 40 may be mounted in an accommodation space of the grip portion 13, and referring to FIG. 3, the control circuit module 40 is electrically connected to a power unit 60 which provides a working power. The control circuit module 40 is signally connected to the flowmeter 20 and the display 30. The control circuit module 40 generates a value of the flow rate based on the measurement signal of the flowmeter 20, and controls the display 30 to show the foregoing flow rate. The control circuit module 40 can also control the display 30 to show a battery level of the power unit 60. It is a common knowledge in the art that the control circuit module 40 receives the measurement signal from the flowmeter 20 and generates the flow rate accordingly.

The control circuit module 40 is signally connected to the flowmeter 20 by a wireless connection or a wired connection. In one feasible embodiment, a substantial signal cable of the flowmeter 20 is configured to be embedded in and along the structure of the container body 10, so as to be connected to the control circuit module 40. In another feasible embodiment, the flowmeter 20 and the control circuit module 40 are signally connected to each other by their wireless transmission circuit module. The wireless transmission circuit module can be a Bluetooth circuit module as an example.

Referring to a feasible embodiment as shown in FIGS. 1 and 2, a fixture base 111 is mounted on an outer side of a side wall of the body portion 11. Referring to another feasible embodiment shown in FIG. 6, a fixture base 111 is mounted on an inner side of the side wall of the body portion 11. The flowmeter 20 is mounted in the fixture base 111, wherein the flowmeter 20 may be snap-fitted, screwed, glued, or tightly fixed in the fixture base 111. One end of the spout portion 12 may also be mounted in the fixture base 111 and may be connected to one end of the flowmeter 20 so as to enable the conduit 200 to directly fluidly communicate with the channel 100. The end of the spout portion 12 may be snap-fitted, screwed, glued, or tightly fixed in the fixture base 111. Referring to FIGS. 1, 2 and 6, a seal ring 50 may be mounted between the fixture base 111 and a peripheral surface of the flowmeter 20, and another seal ring 51 may be mounted between the one end of the spout portion 12 and the fixture base 111, and the seal rings 50, 51 may be, for example, elastic O-rings, which may be mounted in a groove (such as groove 112 shown in FIG. 2) on the inner wall of the fixture base 111, to prevent leakage of liquid.

In summary, when a user lifts the container of the present invention and pours out the liquid, the liquid flows out of the container body 10 through the conduit 200 of the flowmeter 20 and the channel 100 of the container body 10, and the measurement signal output by the flowmeter 20 corresponds to the flow rate of the liquid through the conduit 200. As a result, the control circuit module 40 can obtain the flow rate of the liquid poured out of the container body 10 based on the measurement signal, and additionally the control circuit module 40 controls the display 30 to show the flow rate upon which the user is based to carefully control the flow rate of the poured liquid.

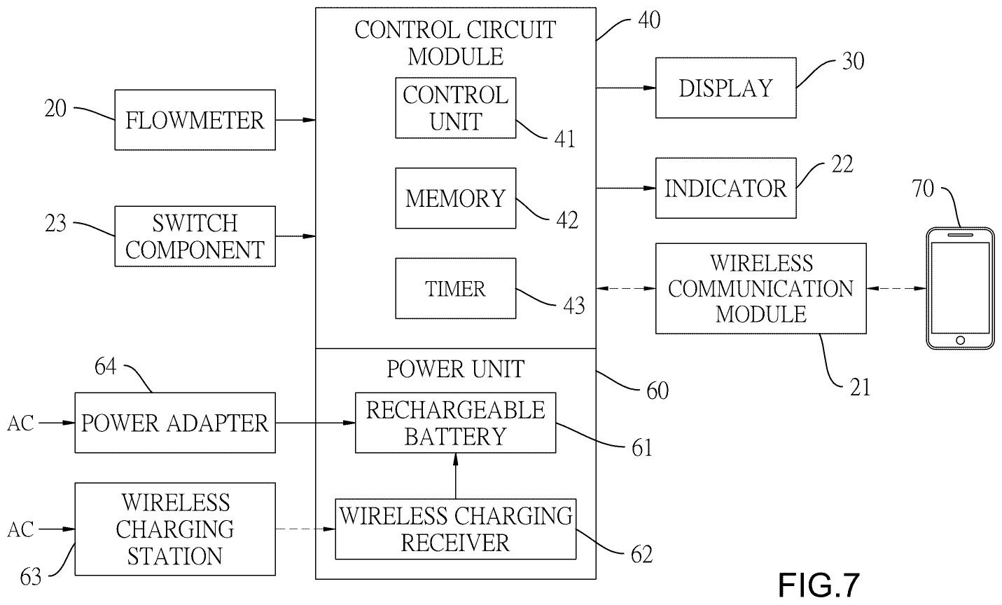

Referring to FIG. 7, the control circuit module 40 is configured to be signally connected to an electronic device 70. For example, the control circuit module 40 can establish a connection with the electronic device 70 via a wireless communication module 21 for data transmission. The wireless communication module 21 can be, for example, a Wi-Fi circuit module or a Bluetooth circuit module. The electronic device 70 can be, for example, a user's smart phone or a tablet computer. In this way, the control circuit module 40 can transmit the flow rate, a time counted by the timer 43, and other related data to the electronic device 70 for displaying, and the electronic device 70 can also store such data as historical records, so as to facilitate the user to keep track of the coffee brewing status through the electronic device 70.

Referring to FIG. 7, the control circuit module 40 may be signally connected to an indicator 22. The indicator 22 may be an indicator light or a speaker as an example to alert a user via light or sound. The indicator 22 may be mounted in the container body 10, for example, in the body portion 11 or the grip portion 13. The control circuit module 40 may be signally connected to a switch component 23, which can be, for example, a touch switch, a push button switch, or a microswitch for triggering the control unit 41 to perform a particular function.

The following is an example of the application of the container of the present invention for brewing coffee. Brewing time is one of the factors affecting the tastes of the hand-drip coffee. The switch component 23 is configured to trigger a timer function. For example, when the control unit 41 determines that the switch component 23 is pressed down, the control unit 41 performs the timer function and control the display 30 to show an elapsed time counted by the timer function for the user to effectively keep track of the brewing time. Then, when the control unit 41 determines that the switch component 23 is pressed down again while counting the time, the control unit 41 stops the timer function. In addition, the control unit 41 is configured to store at least one flow-rate threshold value, determine which of the flow rate and the at least one flow-rate threshold value is higher, and drive the operation mode of the indicator 22 according to the determination result. For example, the at least one flow-rate threshold value may comprise a first flow-rate threshold value TH1 and a second flow-rate threshold value TH2, and TH1<TH2. When the control unit 41 determines that the flow rate is higher than TH1 and lower than TH2, the indicator 22 is controlled by the control unit 41 to emit one “Beep” sound. When the control unit 41 determines that the flow rate is higher than TH2, the indicator 22 is controlled by the control unit 41 to emit two consecutive “Beep” sounds. Accordingly, the indicator 22 can assist the user by reminding the user, through sounds, of a flow rate of the liquid poured by the user.

Please refer to FIG. 7: the power unit 60 may include a rechargeable battery 61. The rechargeable battery 61 is electrically connected to the control circuit module 40 to supply a working power. The rechargeable battery 61 could be charged by at least one of the wireless charging and wired charging.

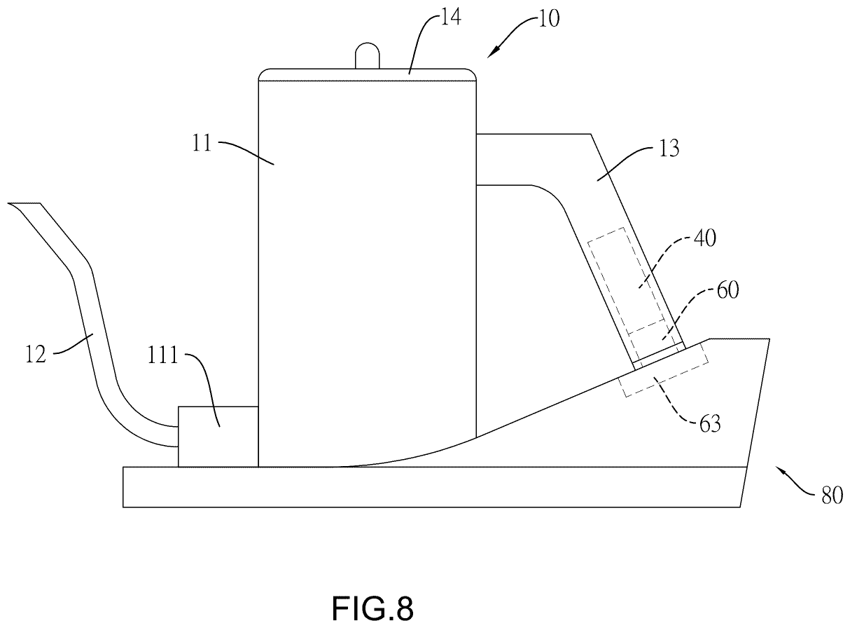

For the wireless charging, the power unit 60 can include a wireless charging receiver 62, which is electrically connected to the rechargeable battery 61. Correspondingly, please refer to FIG. 8: the container of the present invention can be mounted on a base 80 with a wireless charging station 63. When the container of the present invention is put on the base 80, the position of the wireless charging station 63 corresponds to the position of a coil of the wireless charging receiver 62, so that the coil of the wireless charging receiver 62 can inductively receive and convert an output magnetic field from the wireless charging station 63 to a charging power to charge the rechargeable battery 61. For the wired charging, please refer to FIG. 7: the power unit 60 can be electrically connected to a power adapter 64 through a substantial charge cable or connector. The power adapter 64 is used to convert an AC power from an electrical grid into a charging power to charge the rechargeable battery 61. The special characteristics of wireless charging is that the container of the present invention can be charged directly as long as it is mounted on the base 80, which further improves usage convenience.

The technical principles of the present invention are described above in connection with specific embodiments. These descriptions are only intended to explain the principles of the present invention, and are not to be construed in any way as a limitation on the scope of protection of the present invention. Based on the explanations herein, other specific embodiments of the present invention can be associated by those skilled in the art without creative labor, and these equivalent variations or substitutions are included in the scope limited by the claims of this application.

Although the present invention has been disclosed as above by way of a preferred embodiment, it is not intended to limit the present invention, and any one skilled in the art may make certain changes and modifications without departing from the spirit and scope of the present invention, and therefore the scope of protection of the present invention shall be subject to the scope of the appended patent claims as defined herein.

What is claimed is:

1. A container capable of displaying a flow rate, including:
a container body, having a channel;
a flowmeter, mounted in the container body and having a conduit for sensing a liquid flow, wherein the conduit fluidly communicates with the channel of the container body;
a display, mounted on the container body; and
a control circuit module, mounted in the container body and signally connected to the flowmeter and the display, wherein the control circuit module controls the display to show a flow rate based on a measurement signal of the flowmeter.

2. The container capable of displaying a flow rate as claimed in claim 1, wherein the container body includes a body portion and a spout portion, and the channel is formed in the spout portion.

3. The container capable of displaying a flow rate as claimed in claim 1, wherein the conduit directly fluidly communicates with the channel.

4. The container capable of displaying a flow rate as claimed in claim 2, wherein a fixture base is mounted on an outer side or an inner side of a side wall of the body portion, and the flowmeter is mounted in the fixture base; and
wherein one end of the spout portion is mounted in the fixture base and connected to one end of the flowmeter, so that the conduit directly fluidly communicates with the channel.

5. The container capable of displaying a flow rate as claimed in claim 4, wherein a seal ring is mounted between the fixture base and an outer peripheral surface of the flowmeter.

6. The container capable of displaying a flow rate as claimed in claim 4, wherein a seal ring is mounted between the fixture base and the end of the spout portion mounted in the fixture base.

7. The container capable of displaying a flow rate as claimed in claim 1, wherein the control circuit module is electrically connected to a power unit for wireless charging or wired charging.

8. The container capable of displaying a flow rate as claimed in claim 1, wherein the control circuit module establishes a connection with an electronic device via a wireless communication module for data transmission.

9. The container capable of displaying a flow rate as claimed in claim 1, wherein the control circuit module is signally connected to a switch component configured to trigger a timer function; and
wherein the control circuit module controls the display to show a time counted by the timer function.

10. The container capable of displaying a flow rate as claimed in claim 1, wherein the control circuit module is signally connected to an indicator;
the control circuit module determines which of the flow rate and at least one flow-rate threshold is higher, and accordingly drives an operation mode of the indicator.
